(19) United States
(12) Patent Application Publication
(10) Pub. No.: US 2012/0171996 A1
(43) Pub. Date: Jul. 5, 2012

(54) METHOD FOR ENABLING OPERATION OF A WIRELESS MODEM

(75) Inventors: Iulian Mocanu, Langley (CA); Mihael Maria Christian Aksmanovic, Vancouver (CA)

(73) Assignee: Sierra Wireless, Inc., Richmond (CA)

(21) Appl. No.: 12/982,417

(22) Filed: Dec. 30, 2010

(51) Int. Cl. H04W 12/00

(52) U.S. Cl. 455/411

(57) ABSTRACT

The present invention provides a method for enabling operation of a wireless modem configured for operation with a Subscriber Identity Module (SIM). The method comprises determining a personal identification number (PIN) based at least in part on a predetermined network domain; configuring the SIM to release wireless network access data only upon providing the PIN; determining a network domain of a user session on a user device, the user device operatively connected to the wireless modem; determining a SIM-unlock code based at least in part on the network domain associated with the user device; providing the SIM-unlock code to the SIM; and comparing the SIM-unlock code to the PIN; whereby wireless network access is enabled only if at least the network domain associated with a user device corresponds with the predetermined network domain.

### TECHNICAL FIELD

The present technology pertains in general to operation of a wireless modem configured for operation with a Subscriber Identity Module (SIM). Specifically the present technology pertains to a method for enabling operation of a wireless modem in combination with predetermined characteristics associated with a user session on a user device.

### BACKGROUND

Wireless modems, also sometimes referred to as wireless wide area network (WWAN) modems, cellular modems and other names, communicate with a WWAN communication system such as a cellular communication system and provide packet data services to user devices. Wireless modems exchange data with user devices using a Universal Serial Bus (USB), PC Card, CardBus, Ethernet, WiFi, Bluetooth or other interface, for example. Wireless modems typically include a WWAN transceiver such as a cellular transceiver for exchanging data with the WWAN communication system. The WWAN communication system is connected to a public switching system such as a public switched telephone network (PSTN) and/or the Internet. The wireless modem performs the necessary timing and translation functions to provide data packet services between the user device and the WWAN communication system.

A conventional wireless modem is configured to communicate with a WWAN communication system using a Subscriber Identity Module (SIM), which is typically provided on a SIM card. While the SIM can be configured to require a personal identification number (PIN) before it releases data that is required for enabling access to the WWAN communication system, operation of a conventional wireless modem is typically not otherwise restricted. As such wireless modems may be operated in many ways beyond intended uses and the cost for operation of wireless modems can be poorly controlled by non-user subscribers. For example, control of operating cost beyond the intended use of wireless modems may be of importance to corporate subscribers providing their staff with wireless modems.

Accordingly, there is a need for a method for locking/restricting operation of a wireless modem.

This background information is provided to reveal information believed by the applicant to be of possible relevance to the present invention. No admission is necessarily intended, nor should be construed, that any of the preceding information constitutes prior art against the present invention.

### SUMMARY

An object of the present technology is to provide a method for enabling operation of a wireless modem. In accordance with one aspect of the present technology, there is provided a method for enabling operation of a wireless modem, the wireless modem configured for operation with a Subscriber Identity Module (SIM), the method comprising: determining a personal identification number (PIN) based at least in part on a predetermined network domain; configuring the SIM to release wireless network access data only upon providing the PIN; determining a network domain of a user session on a user device, the user device operatively connected to the wireless modem; determining a SIM-unlock code based at least in part on the network domain associated with the user device; providing the SIM-unlock code to the SIM; and comparing the SIM-unlock code to the PIN; whereby wireless network access is enabled only if at least the network domain associated with a user device corresponds with the predetermined network domain.

In accordance with another aspect of the present technology, there is provided a method for operating a wireless modem, the wireless modem configured for operation with a Subscriber Identity Module (SIM), the SIM configured to release wireless network access data only upon providing a personal identification number (PIN) based at least in part on the predetermined network domain; the method comprising: determining a network domain associated with a user session on a user device, the user device operatively connected to the wireless modem; determining a SIM-unlock code based at least in part on the network domain associated with the user device; providing the SIM-unlock code to the SIM; and comparing the SIM-unlock code to the PIN; whereby wireless network access is enabled only if at least the network domain associated with a user device corresponds with the predetermined network domain.

In accordance with another aspect of the present technology, there is provided a method for configuring a Subscriber Identity Module (SIM) for use with a wireless modem configured for use with the SIM, the SIM intended for use with a predetermined network domain, the method comprising: determining a personal identification number (PIN) based at least in part on the predetermined network domain; and configuring the SIM to enable wireless network access only upon providing the PIN.

### BRIEF DESCRIPTION OF THE FIGURES

FIG. 1 illustrates a block diagram of a communication system including a wireless modem for operatively coupling a user device to a WWAN communication system.

FIG. 2 illustrates a flow diagram of a method for enabling operation of a wireless modem according to embodiments of the present technology.

### DETAILED DESCRIPTION OF THE INVENTION

### Definitions

As used herein, the term “about” refers to a +/−10% variation from the nominal value. It is to be understood that such a variation is always included in a given value provided herein, whether or not it is specifically referred to.

As used herein, the term “network domain” may refer to a collection of associated elements such as computing devices or the designation, identification or name used to refer to these associated elements, as the case may be. A network domain can refer to a group of computing devices that are associated via one or more organizational aspects such as user account information and/or one or more security policies, for example. For this purpose, a network domain may include one or more domain controllers that manage the organizational aspects for the computing devices and/or users that are members of the network domain. A network domain can be a Microsoft Windows™ or other network domain. A Windows™ network domain may include one or more Windows™ domain controllers, for example.

Unless defined otherwise, all technical and scientific terms used herein have the same meaning as commonly understood by one of ordinary skill in the art to which this invention belongs.

The instant technology provides a method for enabling operation of a wireless modem when the wireless modem is used in combination with a user device that is associated with one or more predetermined aspects of a user session. For example, predetermined aspects of a user session may be characterized by a predetermined network domain or other predetermined aspects that are associated with the user session as described herein.

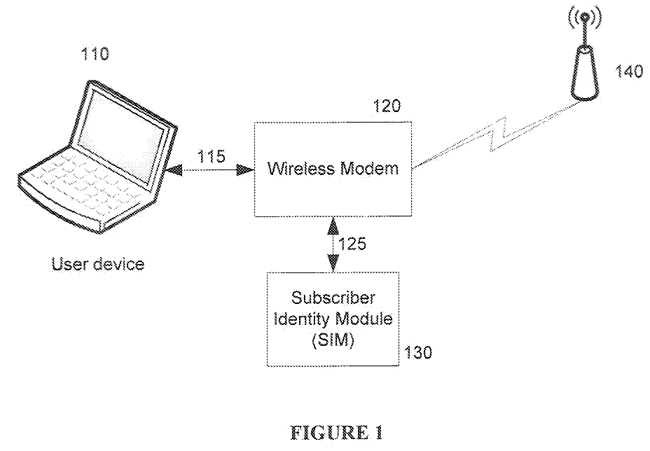

FIG. 1 illustrates a block diagram of a communication system including a wireless modem 120 for operatively coupling a user device 110 to a wireless wide area network (WWAN) communication system 140. The WWAN communication system 140 can be a UMTS, GPRS, EDGE, CDMA2000, GSM, CDPD, Mobitex, HSDPA, HSUPA, 3G or other WWAN communication system, for example. The wireless modem is configured for operation with a Subscriber Identity Module (SIM) 130 via a corresponding operative connection 125. The SIM 130 is used to store wireless network access data and perform various tasks that are required to establish a wireless network connection with the WWAN communication system. The wireless network access data can include one or more of: an integrated circuit card identifier (ICC-ID), international mobile subscriber identity (IMSI), authentication key (Ki), local area identity (LAI), WWAN-specific emergency number, short message service center (SMSC) number, service provider name (SPN), service dialing numbers (SDN), advice-of-charge parameters, value added service (VAS) applications and/or other data.

Some or all of the wireless network access data may be used to identify the SIM within the WWAN communication system and associate the SIM with a specific subscriber account. The WWAN communication system uses some or all of this information to track communications to and/or from the wireless modem and determine cost associated therewith. Ways for performing cost accounting can be performed by WWAN communication systems and corresponding specifications are well documented and readily available to a person skilled in the art.

According to embodiments of the instant technology, the SIM is configured to release the wireless network access data only upon providing a personal identification number (PIN). According to embodiments, the PIN is kept hidden from ordinary users who are not authorized to change the PIN, and changing the PIN is reserved to authorized administrators of systems that employ the instant technology. Depending on the embodiment, systems that employ the instant technology may or may not be configured to reveal PINs to administrators.

Depending on the embodiment, the PIN may include a predetermined number of digits. For example, the PIN may have four to twelve digits. Depending on the embodiment, each digit may comprise numerical or alphanumerical characters from a predetermined alphabet or set of characters.

The user device 110 can be a notebook, laptop, desktop, tablet, handheld or other computing device that can be operatively coupled via an interconnect system 115 to the wireless modem 120. The interconnect system 115 can a USB, PC Card, CardBus. Ethernet or other wired or wireless interconnect system. The user device 110 and wireless modem 120 may also be provided in an integrated manner such as in the form of a personal digital assistant (PDA), smartphone, notebook with integrated wireless modem or other integrated computing device, for example. The SIM 130 may be inserted in the wireless modem 120 or, if the user device and the wireless modem are provided in one integrated device, directly in the integrated device, for example.

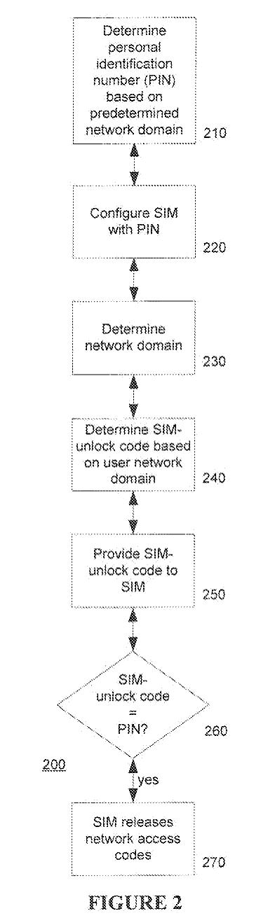

The following, as illustrated in FIG. 2 and further described below, outlines a method for enabling operation of the wireless modem according to embodiments of the present technology. The method can be considered to comprise two stages, a first stage, which involves a method for determining a PIN for configuring a SIM, and a second stage which involves operating the wireless modem that includes generation of a SIM-unlock code. Each stage comprises a number of steps and both stages together can be considered as a method for enabling operation of a wireless modem that enables the wireless modem for communication with the WWAN communication system only in case certain aspects associated with a user session meet certain conditions. Depending on the embodiment, each stage or portion thereof may be implemented in hardware, software and/or firmware such as a computer program product, for example. According to embodiments of the present technology, each stage can be implemented on a user device. For example, the first stage can be employed on a user device that is used in combination with a SIM programming device.

### Method for Configuring the SIM—First Stage

FIG. 2 generally illustrates a flow diagram of a method 200 for enabling operation of a wireless modem according to embodiments of the present technology. This method comprises the two stages noted above. The first stage comprises steps 210 and 220. Step 210 comprises determining a personal identification number (PIN) that is based at least on one predetermined aspect associated with a user session, the wireless modem and/or the SIM. In this respect, it is noted that while the following description refers specifically to a predetermined network domain associated with the user session, this is an example only. Depending on the embodiment, a method for enabling operation of a wireless modem may be based on one or more predetermined aspects associated with a user session, which may or may not include a predetermined network domain.

According to embodiments of the instant technology, the PIN is determined using the outcome of a predetermined key-generating function, such as a formula and/or algorithm. Accordingly the outcome of the key-generating function is used as the PIN for locking the SIM, that is, the PIN is used to encode some or all of the wireless network access data stored in the SIM. According to embodiments of the instant technology, the same key-generating function is (later) used to process actual aspects of a specific user session. For example, the user device and/or the wireless modem compute an outcome of the key-generating function based on the actual aspects of the specific user session that is then used as a SIM-unlock code, as described below with reference to the second stage.

According to an embodiment, the key-generating function is configured to accept the predetermined network domain as a network-domain parameter (not illustrated). Depending on the embodiment, the key-generating function can be injective or non-injective with respect to the relationship between, for example the network-domain parameter, and the PIN. Again, it is noted, that the key-generating function may be configured to use other or additional aspects of the user session as a parameter/parameters.

In step 220 the SIM 130 is then configured to release the wireless network access data only upon providing the PIN, that is, the wireless network access data stored in the SIM can only be accessed when the SIM is unlocked with the PIN. This configuration of the SIM 130 may be referred to as SIM-locked. In other words, when the key-generating function is applied to a network-domain parameter that is different from the predetermined network domain, the SIM cannot be unlocked with the result generated by the key-generating function if the key-generating function is injective or more or less unlikely be unlocked with the result generated by the key-generating function when the key-generating function is non-injective.

Optionally the system may be configured to take into account additional aspects regarding a specific user session of the user device. For example, the key-generating function for determining the PIN may be configured to additionally accept one of more of the following parameters: the ICC-ID, type and/or serial number of the SIM and/or the wireless modem, and/or other characteristics of the wireless modem, the SIM, the WWAN communication system and/or information associated with the user within the network domain. Accordingly, the PEN may be configured so that the SIM can be unlocked only if all predetermined aspects regarding a user session meet their predetermined values. Accordingly, these aspects can go beyond matching the network domain associated with a user session with a predetermined network domain. According to an embodiment, the key-generating function is configured to accept the predetermined network domain as a network domain parameter, the type of the wireless modem and the ICC-ID of the SIM. Accordingly, the outcome of the respective key-generating function when used as a PIN for unlocking the SIM, can only be reproduced, when the type of wireless modem, the SIM and the network domain each match their predetermined value.

### Method for Operating the Wireless Modem—Second Stage

FIG. 2 further illustrates a number of steps that specifically refer to the operation of the wireless modem in combination with a SIM that is locked with a PIN as described herein. These steps can be implemented in software, hardware, and/or firmware on the user device, the wireless modem or in different combinations on both. For example, the method can be employed in driver software of a wireless network connection manager and/or as part of the operating system of the user device. When the wireless modem is operatively connected to a user device, the wireless modem can be used to provide communication between the user device and the WWAN communication system. According to an embodiment, these steps are implemented on the user device only.

When the SIM is locked with a PIN that is determined based on one or more aspects associated with a user session as described herein, the wireless modem can be enabled/activated to access the WWAN communication system provided the SIM is unlocked with the correct SIM-unlock code, that is the SIM-unlock code has to correspond with the PIN that was used to lock the SIM. According to embodiments of the instant technology, the SIM-unlock code is determined using the same key-generating function that is used to generate the SIM's PIN. For this purpose, the outcome of the key-generating function will unlock the SIM, when the characteristics of the user session which are provided as parameters to the key-generating function meet the characteristics that were used to generate the PIN. Depending on the embodiment, one or more of the network domain, the ICC-ID, the wireless modem type and/or other aspects associated with the user session are be the same as those used during PIN generation.

Steps 230 and onwards of the flow diagram as illustrated in FIG. 2 specifically refer to a method for operating a wireless modem according to an embodiment of the present technology, in which the SIM-unlock code is based solely, on the network domain. It is noted that depending on the embodiment, the SIM-unlock code can be based on one or more of the network domain, the ICC-ID, the wireless modem type and/or other aspects associated with the user session. Depending on the embodiment, the corresponding key-generating function may have the same number or more parameters as there are aspects of the user session that are employed to determine the PIN. According to an embodiment, parameters of the key-generating function that are not used in the determination of the PIN may be set to predetermined (default) values.

Step 230 comprises determining the network domain with which the user session is associated. For example, the user session may be defined, at least in part, by the account that the user has invoked when logging into the operating system of the user device. Next follows step 240 which comprises determining a SIM-unlock code based on the network domain determined in step 230. As described, the SIM-unlock code is determined based upon the key-generating function and corresponds with the outcome thereof. Following in step 250, the SIM-unlock code is provided to the SIM. The SIM is configured to determine in step 260, if the provided SIM-unlock code is correct, that is, whether it corresponds with the PIN of the SIM. If the SIM-unlock code corresponds with the PIN, the SIM will release, in step 270, wireless network access data that is required to establish an operative connection between the wireless modem and the WWAN communication system.

Details of how and in which components processes involved in steps 260 and 270 are invoked, may depend on the specific type of SIM. Depending on the SIM, corresponding processes may be performed by the SIM entirely independently with or without use of or in combination with other components. Such processes may involve use of one or more authentication keys and/or generation of one or more encryption keys. Authentication keys and/or encryption keys may be used to encode data communicated wirelessly between the wireless modem and the WWAN. Encryption keys may be generated through one or more communications of data between the wireless device and the WWAN. For this purpose and according to some embodiments, processes may be employed that are well documented and readily known in the art.

It will be appreciated that, although specific embodiments have been described herein for purposes of illustration, various modifications may be made without departing from the spirit and scope of the invention. In particular, it is within the scope of the invention to provide a computer program product or program element, or a program storage or memory device such as a transmission medium, magnetic or optical wire, tape or disc, or the like, for storing signals readable by a machine, for controlling the operation of a computer according to the method of the invention and/or to structure its components in accordance with the system of the invention.

Further, each step of the methods may be executed on a general computer, such as a personal computer, server or the like and pursuant to one or more, or a part of one or more, program elements, modules or objects generated from any programming language, such as C, C++, Java, Perl, PL/l, or the like. In addition, each step, or a file or object or the like implementing each said step, may be executed by special purpose hardware or a circuit module designed for that purpose.

It is obvious that the foregoing embodiments are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for enabling operation of a wireless modem, the wireless modem configured for operation with a Subscriber Identity Module (SIM), the method comprising:
a. determining a personal identification number (PIN) based at least in part on a predetermined network domain;
b. configuring the SIM to release wireless network access data only upon providing the PIN;
c. determining a network domain of a user session on a user device, the user device operatively connected to the wireless modem;
d. determining a SIM-unlock code based at least in part on the network domain of the user session;
e. providing the SIM-unlock code to the SIM; and
f. comparing the SIM-unlock code to the PIN;
whereby wireless network access is enabled only if at least the network domain of the user session corresponds with the predetermined network domain.

2. The method according to claim 1, wherein the determining the PIN comprises computing a predetermined key-generating function, the predetermined key-generating function configured to accept one or more parameters including a domain name parameter, and providing the predetermined network domain as the domain name parameter.

3. The method according to claim 2, wherein the key-generating function further includes a parameter for a serial number associated with the wireless modem, a parameter for an integrated circuit card identifier (ICC-ID) associated with the SIM, a parameter for an international mobile subscriber identity (IMSI) associated with the SIM and/or a parameter for a serial number associated with the SIM.

4. The method according to claim 2, wherein the determining the SIM-unlock code comprises computing the predetermined key-generating function based on the network domain of the user session on the user device.

5. The method according to claim 3, wherein the determining the SIM-unlock code comprises computing the predetermined key-generating function based on the network domain of the user session on the user device and the serial number associated with the SIM.

6. The method according to claim 3, wherein the determining the SIM-unlock code comprises computing the predetermined key-generating function based on the network domain of the user session on the user device and the ICC-ID associated with the SIM.

7. The method according to claim 3, wherein the determining the SIM-unlock code comprises computing the predetermined key-generating function based on the network domain of the user session on the user device and the IMSI associated with the SIM.

8. The method according to claim 3, wherein the determining the SIM-unlock code comprises computing the predetermined key-generating function based on the network domain of the user session on the user device and two or more of the serial number, the ICC-ID and/or the IMSI associated with the SIM.

9. A method for operating a wireless modem, the wireless modem configured for operation with a Subscriber Identity Module (SIM), the SIM configured to release wireless network access data only upon providing a personal identification number (PIN) based at least in part on the predetermined network domain; the method comprising:
a. determining a network domain of a user session on a user device, the user device operatively connected to the wireless modem;
b. determining a SIM-unlock code based at least in part on the network domain associated with the user device;
c. providing the SIM-unlock code to the SIM; and
d. comparing the SIM-unlock code to the PIN;
whereby wireless network access is enabled only if at least the network domain of the user session corresponds with the predetermined network domain.

10. The method according to claim 9, wherein the determining the SIM-unlock code comprises computing a predetermined key-generating function, the predetermined key-generating function configured to accept one or more parameters including a domain name parameter, and providing the network domain of the user session on the user device as the domain name parameter.

11. The method according to claim 10, wherein the key-generating function further includes a parameter for a serial number associated with the wireless modem, a parameter for an integrated circuit card identifier (ICC-ID) associated with the SIM, a parameter for an international mobile subscriber identity (IMSI) associated with the SIM and/or a parameter for a serial number associated with the SIM.

12. The method according to claim 11, wherein the determining the SIM-unlock code comprises computing the predetermined key-generating function based on the network domain of the user session on the user device and the serial number associated with the SIM.

13. The method according to claim 1 wherein the determining the SIM-unlock code comprises computing the predetermined key-generating function based on the network domain of the user session on the user device and the ICC-ID associated with the SIM.

14. The method according to claim 11, wherein the determining the SIM-unlock code comprises computing the predetermined key-generating function based on the network domain of the user session on the user device and the IMSI associated with the SIM.

15. The method according to claim 11, wherein the determining the SIM-unlock code comprises computing the predetermined key-generating function based on the network domain of the user session on the user device and two or more of the serial number, the ICC-ID and/or the IMSI associated with the SIM.

16. A method for configuring a Subscriber Identity Module (SIM) for use with a wireless modem configured for use with the SIM, the SIM intended for use with a predetermined network domain, the method comprising:
a. determining a personal identification number (PIN) based at least in part on the predetermined network domain; and
b. configuring the SIM to enable wireless network access only upon providing the PIN.

17. The method according to claim 16, wherein the determining the PIN comprises computing a predetermined key-generating function, the predetermined key-generating function configured to accept one or more parameters including a domain name parameter, and providing the predetermined network domain as the domain name parameter.

18. The method according to claim 17, wherein the key-generating function further includes a parameter for a serial number associated with the wireless modem, a parameter for an integrated circuit card identifier (ICC-ID) associated with the SIM, a parameter for an international mobile subscriber identity (IMSI) associated with the SIM and/or a parameter for a serial number associated with the SIM.

19. A computer program product comprising a computer readable memory storing computer executable instructions thereon that when executed by a computer perform the method of claim 1.

20. A computer program product comprising a computer readable memory storing computer executable instructions thereon that when executed by a computer perform the method of claim 9.

21. A computer program product comprising a computer readable memory storing computer executable instructions thereon that when executed by a computer perform the method of claim 16.
